(19) United States
(12) Patent Application Publication
(10) Pub. No.: US 2016/0139493 A1
(43) Pub. Date: May 19, 2016

(54) CASE FOR A PERSONAL ELECTRONICS DEVICE WITH EXTERNAL LENS MOUNT

(71) Applicants: Jonas Johansson, Santa Barbara, CA (US); Theo Doussineau, Santa Barbara, CA (US)

(72) Inventors: Jonas Johansson, Santa Barbara, CA (US); Theo Doussineau, Santa Barbara, CA (US)

(21) Appl. No.: 14/548,178

(22) Filed: Nov. 19, 2014

(51) Int. Cl. G03B 17/14; H04N 5/225; G02B 13/00

(52) U.S. Cl. CPC G03B 17/14; G02B 13/0015; H04N 5/2254

(57) ABSTRACT

A protective case for a Personal Electronic Device (PED) with a camera aperture with provision for mounting external interchangeable lenses, including a first portion of shock dampening material, and a metal interchangeable lens retention element with an aperture bonded to the case disposed with the retention aperture aligned with the camera aperture.

### BACKGROUND

The specification relates to protective cases for Personal Electronic Devices (PED's) with integrated cameras and in particular a case with a lens mount for external interchangeable lenses whose mounting elements are twist on-off metal structures.

Protective cases for PED's such as smartphones, tablets and the like are popular with many users to provide a measure of protection for these expensive, delicate devices during normal use. Many PED's also include an integrated camera which often may often employ a small, thin lens of limited optical quality. Protective cases may provide a mounting structure to allow a user to employ a higher quality external lens, which may be mounted to the case aligned with the PED camera lens. Successful mounting of such a lens in a robust manner suitable for multiple install and remove cycles may drive the design of the case.

### BRIEF DESCRIPTION

In some embodiments, a protective case for a PED may be provided that includes an external lens mount compatible with interchangeable lenses with metal mounting structures. The materials of the case may be chosen and arranged to maintain the shock dampening aspects for protection of the PED while providing a suitable mounting provision capable of withstanding many cycles of twist on/twist off cycles of a metal mounting structure.

In some embodiments a protective case may be provided for a Personal Electronic Device (PED) with provision for mounting external interchangeable lenses aligned with the PED camera aperture, comprising; a first portion of shock dampening material, and a metal interchangeable lens retention element bonded to the case disposed with a retention element aperture aligned with the camera aperture.

In some embodiments the case may further include a second portion disposed around the camera aperture of stiff material, bonded to the first portion

In some embodiments the retention element may include at least one of a threaded aperture or a bayonet mating structure.

In some embodiments the bonding between the materials, and between the materials and the retention element, may include at least one of adhesive bonding, overmolding, spot welding, or mechanical interleaved fastening.

In some embodiments the first portion material may be Thermal PolyUrethane (TPU).

In some embodiments the second portion material may polycarbonate.

In some embodiments the retention element may be an aluminum threaded aperture plate compatible with small format interchangeable lenses with aluminum threaded mounts.

### BRIEF DESCRIPTION OF THE DRAWINGS

FIGS. 1a and 1b show two views of a case, according to an illustrative embodiment;

FIG. 2 shows an exemplary interchangeable lens, according to an illustrative embodiment;

FIGS. 3a and 3b show two views of a case and lens, according to an illustrative embodiment;

### DETAILED DESCRIPTION OF ILLUSTRATIVE EMBODIMENTS

One or more embodiments described herein may an interchangeable lens mount for a PED protective case where the lens mount is capable of supporting a large number of lens install/remove cycles with minimal degradation to the mount or the case.

One or more embodiments described herein may provide a mount where the lens mount and the retention mechanism on the case may be of compatible materials.

One or more embodiments may provide a case where shock dampening material is used for portions of the case and a stiffer material for withstanding twist on/twist off cycles of metal elements is used in the vicinity of the lens mount.

One or more embodiments may provide an interchangeable lens mount for a PED case utilizing an aluminum threaded retainer compatible with miniature threaded aluminum barrel lenses including wide-angle, fisheye, microscopic, and telescopic lenses.

Cameras in PED's often utilize small thin lenses that fit flush into the camera body. In many cases users may find it desirable to have the option of using a higher quality or different type of lens such as a wide angle or telescopic lens for example. A class of miniature high quality interchangeable lenses have been developed by the inventors of the current application that are sized on the order of a couple inches or less in diameter and couple inches or less in used with a device the size of a smartphone or tablet. However these better quality lenses have bodies made of metal and their mounting barrels are also metal, which are threaded and intended to mount by being screwed into a threaded receptacle. Alternatively, metal-bodied miniature lenses also may employ bayonet mounts. In either case, the acts of installing and removing the lens from a retention element may be twist on/twist off operations.

Most PED's do not include provision for mounting an external lens, but since many PED users employ a protective case for their PED's, cases which include provision for mounting am external lens over the PED camera lens are possible. However utilizing metal bodied lenses with PED cases may be problematic.

To provide protection against drops and impact, many PED protective cases are made out of a shock dampening material, such as a compliant thermal plastic. Thermal PolyUrethane (TPU) for example may be an effective material having both the structural properties needed to conform to and retain the PED while providing a significant measure of shock protection. However TPU and similar materials may be incompatible with the high torsion actions of twisting or screwing a metal bodied lens into and out of the case. Such material may not retain structural integrity around an aperture with a metal bodied object torsioning within the aperture for large numbers of repeated cycles

Moreover, metal threads or bayonets may best be used for repeated cycles if the mating retention element is made of the same or at least similar material. Metal threaded barrels mated to plastic threaded apertures may not be a suitable choice for a mount intended to support large numbers of installation cycles over a long period of time

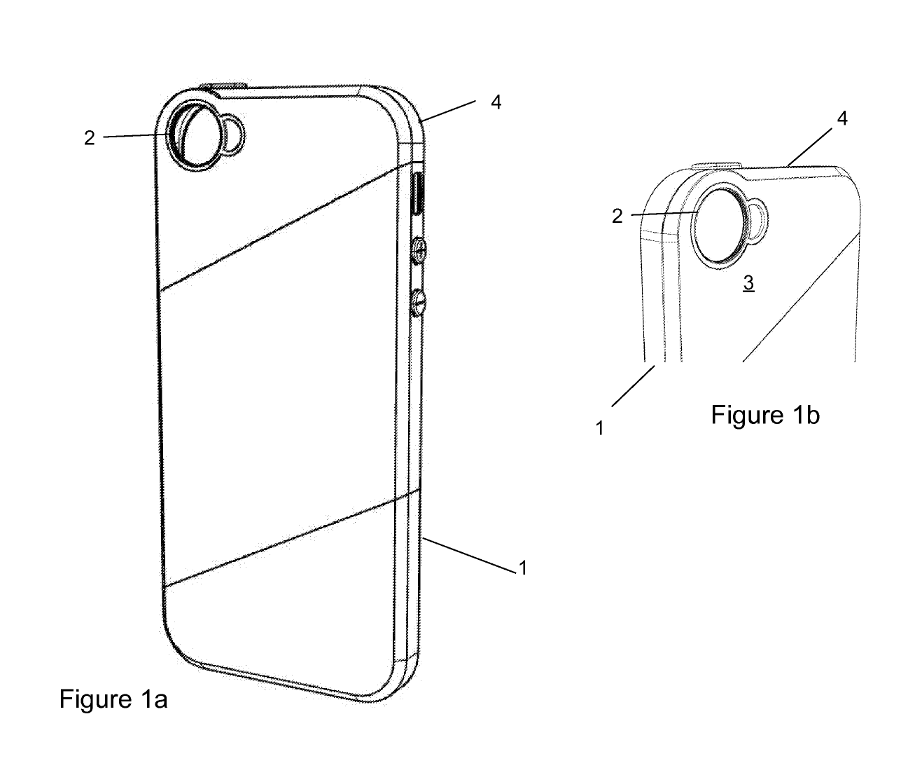

Referring to FIG. 1a an exemplary embodiment of a case 1 is shown. Case 1 may include a lens mount metal retention element 2 configured to mount interchangeably a type of miniature metal bodied lens. All or a portion of the case may be a shock dampening material 4, such as TPU for example, as is common for PED cases. Metal lens retention element 2, which may include an aperture surrounded by a retention mechanism such as threads or bayonet mount, is bonded to the case with the aperture of the retention element substantially aligned over the PED camera aperture as shown. The three elements are bonded together into a unitary case. The bonding may be any of a variety of types used singly or in combination. Bonding approaches include adhesives, overmolding, tack or spot welding, and mechanical interleaving such as teeth pressed into the material along the interface between the lens retention element and the case material.

Alternatively, as shown in FIG. 1b a second material 3 may be used in the vicinity of and surrounding the metal lens mount 2 which may be a stiff plastic chosen suitable to improve resistance to the torsional stresses produce by the operation of the lens mount 2. An exemplary suitable material is polycarbonate sheet of a few mils thickness. In some illustrative embodiments this material mat be on the order of 1 mm thick. Thus in this alternative embodiment, three elements may make up the exemplary case, a body of a shock dampening material, a region of a stiff material for improved resistance to torsional cycles of the mount, and the mount itself chosen to be a metal compatible with the intended type of interchangeable lenses.

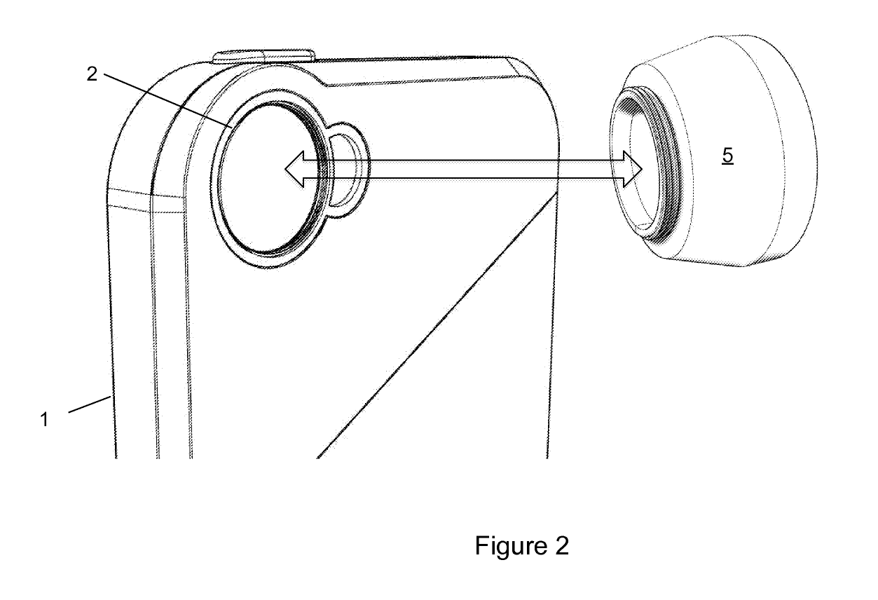

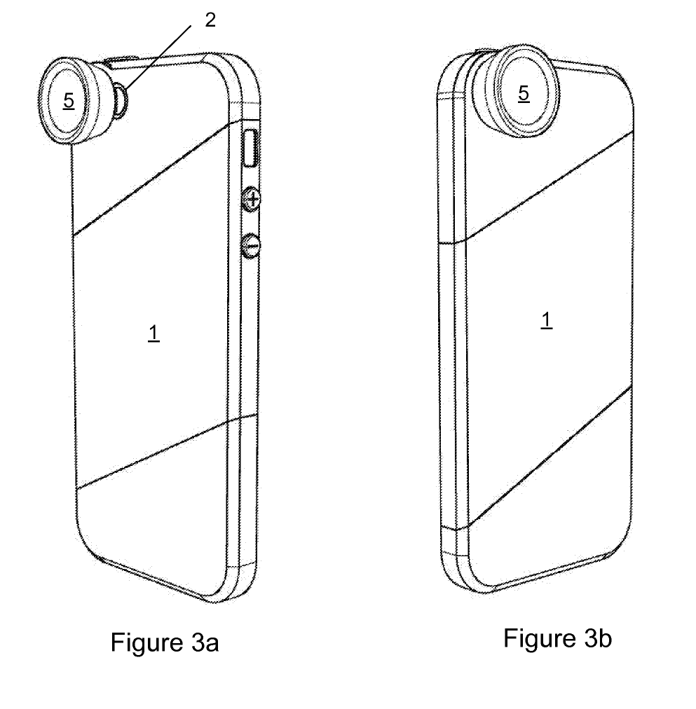

FIG. 2 shows a particular illustrative embodiment. Lens 5 is intended to be a class of high quality miniature lenses produced by the inventors, with aluminum bodies, and the mounting mechanism may be threads on the aluminum barrel. For this lens type, lens mount 2 may be a threaded aluminum aperture plate, with the aperture aligned with the PED camera lens when case 1 is installed on a PED. This type of lens is made in a variety of types, fisheye, wide angle, microscopic and telescopic, providing many options to the user. They are generally much higher quality than most PED camera lenses, and as can be seen are a convenient size. With an exemplary case of the type disclosed, the case will support a large number of mount/dismount cycles. FIGS. 3a and 3b illustrate an embodiment of the case 1 showing the lens 5 in proximity to the mount 2 and also mounted.

The embodiments described herein are exemplary. Modifications, rearrangements, substitute materials, etc. may be made to these embodiments and still be encompassed within the teachings set forth herein.

1. A protective case for a Personal Electronic Device (PED) with a camera aperture, the case having provision for mounting external interchangeable lenses, comprising;
a first portion of shock dampening material, and;
a metal interchangeable lens retention element with an aperture bonded to the case disposed with the retention aperture aligned with the camera aperture.

2. The case of claim 1 further comprising a second portion of a stiffer material bonded to the first portion, and the retention element is boded to the second portion.

3. The case of claim 1, wherein the retention element comprises at least one of a threaded aperture or a bayonet mating structure.

4. The case of claim of claim 1, wherein the bonding between the material and the retention element include at least one of;
adhesive bonding,
overmolding,
spot welding,
mechanical interleaved fastening.

5. The case of claim of claim 2, wherein the bonding between the materials and between the material and the retention element include at least one of;
adhesive bonding,
overmolding,
spot welding,
mechanical interleaved fastening.

6. The case of claim 1, wherein the first portion material is Thermal PolyUrethane (TPU).

7. The case of claim 2, wherein the second portion material is polycarbonate.

8. The case of claim 1 wherein the retention element is an aluminum thread plate compatible with small format interchangeable lenses with aluminum threaded mounts.
